(19) United States
(12) Patent Application Publication
(10) Pub. No.: US 2026/0300102 A1
(43) Pub. Date: Oct. 1, 2026

(54) BACKUP SYSTEM AND BACKUP METHOD

(71) Applicant: Hitachi Vantara, Ltd., Kanagawa-ken (JP)

(72) Inventors: Seunghwan OH, Yokohama-shi (JP); Yuta NISHIHARA, Yokohama-shi (JP); Shwe Zin PHYO, Yokohama-shi (JP)

(21) Appl. No.: 19/292,413

(22) Filed: Aug. 6, 2025

(30) Foreign Application Priority Data
Mar. 27, 2025 (JP) 2025-053717

(51) Int. Cl. G06F 11/1446; G06F 21/60; H04L 9/32

(52) U.S. Cl. CPC G06F 11/1458; G06F 21/602; H04L 9/32; G06F 2201/805

(57) ABSTRACT

A backup system includes a production storage system and a plurality of backup devices. The production storage system includes a split processor, an encryption processor, and a storage processor. The split processor creates a plurality of pieces of divided data by dividing backup target data in the storage system. The encryption processor creates a plurality of parities of the plurality of pieces of divided data and encrypts the plurality of pieces of divided data and the plurality of parities to create a plurality of pieces of encrypted divided data and a plurality of encrypted parities. The storage processor stores a plurality of pieces of encrypted divided data and a plurality of encrypted parities in the plurality of backup devices in a distributed manner.

### CROSS-REFERENCE TO RELATED APPLICATIONS

This application claims benefit of priority from JP 2025-053717, filed Mar 27, 2025, the contents of which are incorporated herein by reference.

### BACKGROUND OF THE INVENTION

### 1. Field of the Invention

The present disclosure relates to a backup system and a backup method.

### 2. Description of the Related Art

Servers (including production data) of business systems are enhanced for security by introduction of security-related artificial intelligence (such as machine learning sign detection), an interface that supports threat hunting, an intrusion detection system, an intrusion prevention system, and the like. In contrast, backup has a problem that is mainly data migration rather than security, and thus has a low ratio of introduction of security technology.

Ransomware is a type of computer virus, and is malware that performs the following tasks of: encrypting data on an infected device; extracting data before encryption; requesting a ransom for restoring the encrypted data; threatening disclosure of the exploited data; and requesting a ransom for forgoing the disclosure of the exploited data. Backup systems are required to take measures against cyberattacks using malware such as ransomware.

Examples of a conventional backup technique include an air gap backup. The air gap backup is a method for storing a backup of backup target data on a production system in a backup system with restriction between the production system operating to provide business and services, and the backup system.

Examples of the air gap backup include a method for performing communication direction control that restricts communication between the production system and the backup system in one direction (it may be referred to below as an “air gap (communication direction control)”), and a method for permitting communication between the production system and the backup system only in a backup time zone (it may be referred to below as an “air gap (time control)”).

The examples of a conventional backup technique also include a backup technique in compliance with a 3-2-1 rule of backup (the backup technique may be referred to below as a “backup technique (3-2-1 rule)”) that is a general technique for ensuring data safety. The 3-2-1 rule of backup is configured as items (1) to (3) below. (1) Three copies are made. That is, original data and two backup data are made. (2) The backup data is stored in two different types of storage devices. (3) One backup data is to be stored off-site. At least one backup is stored at a location physically away from a current location. The backup technique (3-2-1 rule) enables risk of data loss to be significantly reduced in compliance with the 3-2-1 rule of backup.

JP 2011-175578 A discloses a data backup system in which a backup proxy performs tasks of: encrypting data to be stored, the data being received from a server; dividing the encrypted backup data into blocks that are encryption processing units; combining the divided data while preventing the divided data blocks from being continuously included; recording information on the combination in a registration table; and storing the combined data in a plurality of data storage services in a distributed manner.

JP 2015-166988 A discloses a data management method including: selecting storage locations of data to be backed up from a plurality of storage devices based on an evaluation result of a predetermined characteristic; generating a plurality of pieces of divided data by dividing the data to be backed up while satisfying predetermined redundancy (specifically, dividing the data by a secret distribution method); determining the storage locations while preventing all of the plurality of pieces of divided data from being stored in the same storage device; and writing the divided data to each of storage devices at the determined storage locations.

### SUMMARY OF THE INVENTION

The backup system is required to have destruction resistance that prevents both the production data and the backup data from being destroyed once, and leakage resistance that prevents the backup data from being stolen or prevents information leakage of even the backup data stolen.

Unfortunately, the air gap backup (the air gap (communication direction control) and the air gap (time control)) restricts only a communication direction and a communicable time between the production system and the backup system, so that both the production data and the backup data may be destroyed once or information leakage may occur when access rights for the production system and the backup system are illegally acquired by malware or when the production system and the backup system are intruded by some method. For this reason, low data destruction resistance and low leakage resistance are caused.

Although the backup technique (3-2-1 rule) arranges a plurality of copies of backup target data as backup data, only arranging the plurality of copies of backup data does not resolve risk of information leakage. For example, risk of data leakage due to a partial attack against the backup data is sufficiently considered. For this reason, low data leakage resistance is caused.

The technique of JP 2011-175578 A does not store the divided and encrypted data blocks with redundancy, thus causing low destruction resistance. The technique of JP 2015-166988 A stores unencrypted divided data, thus causing low leakage resistance.

The present disclosure has been made in view of the above problems. That is, it is an object of the present disclosure to provide a backup system and a backup method capable of improving data destruction resistance and data leakage resistance.

To solve the above problems, a backup system of the present disclosure includes a storage system including a processing device and a plurality of backup devices. The processing device performs tasks of: creating a plurality of pieces of divided data by dividing backup target data in the storage system; creating a plurality of parities of the plurality of pieces of divided data; creating a plurality of pieces of encrypted divided data and a plurality of encrypted parities by encrypting the plurality of pieces of divided data and the plurality of parities; and storing the plurality of pieces of encrypted divided data and the plurality of encrypted parities in the plurality of backup devices in a distributed manner.

A backup system of the present disclosure is a backup method using a storage system including a processing device and a plurality of backup devices, the backup method causing the processing device to perform tasks of: creating a plurality of pieces of divided data by dividing backup target data in the storage system; creating a plurality of parities of the plurality of pieces of divided data; creating a plurality of pieces of encrypted divided data and a plurality of encrypted parities by encrypting the plurality of pieces of divided data and the plurality of parities; and storing the plurality of pieces of encrypted divided data and the plurality of encrypted parities in the plurality of backup devices in a distributed manner.

The present disclosure enables improvement in data destruction resistance and leakage resistance. Effects described herein are not necessarily limited, and may be any of the effects described in the present disclosure.

### BRIEF DESCRIPTION OF THE DRAWINGS

FIG. 1 is a configuration diagram illustrating a configuration example of a backup system according to an embodiment of the present disclosure;

FIG. 2 is a diagram for illustrating backup target file information;

FIG. 3 is a diagram for illustrating backup device information;

FIG. 4 is a diagram for illustrating key management information;

FIG. 5 is a diagram for illustrating management information;

FIG. 6 is a block diagram illustrating an example of a hardware block configuration of a storage system applied to a production storage system;

FIG. 7 is a schematic configuration diagram illustrating a hardware configuration example of a terminal;

FIG. 8A is a diagram for illustrating an overview of a conventional backup system;

FIG. 8B is a diagram for illustrating an overview of a conventional backup system;

FIG. 8C is a diagram for illustrating an overview of a conventional backup system;

FIG. 9A is a diagram for illustrating an overview of a backup system of the present disclosure;

FIG. 9B is a diagram for illustrating an overview of the backup system of the present disclosure;

FIG. 10 is a flowchart for illustrating backup processing performed by a production storage system;

FIG. 11 is a flowchart for illustrating restoration processing performed by a backup device; and

FIG. 12 is a flowchart for illustrating restoration processing performed by a terminal.

### DESCRIPTION OF THE PREFERRED EMBODIMENTS

Hereinafter, embodiments of the present disclosure will be described with reference to the drawings. All the drawings of the embodiments may indicate the same or corresponding parts with the same reference numerals.

Although various types of information may be described with expressions such as a “table” and a “record” in the description below, the various types of information may be expressed with a data structure other than these. Although expressions such as an “ID” and a “name” are used to describe identification information, the expressions can be replaced with each other, and identification information described by other expressions may be used. Although processing may be described with a program as a subject in the description below, the processing may be described with a processor, a CPU, or a processing device as the subject instead of the program.

### Embodiment

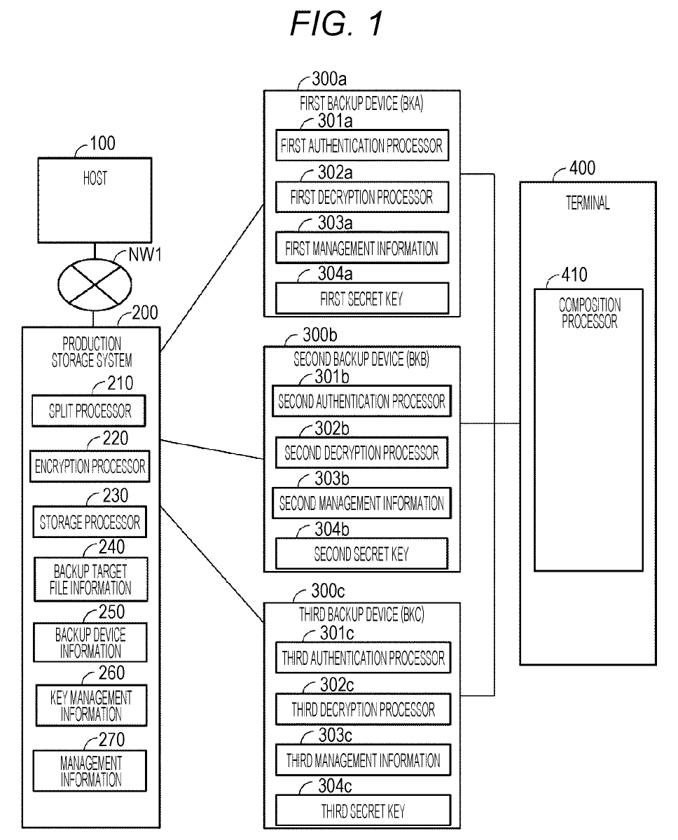

FIG. 1 is a configuration diagram illustrating a configuration example of a backup system according to an embodiment of the present disclosure. As illustrated in FIG. 1, the backup system includes a host 100, a production storage system 200, a first backup device 300a, a second backup device 300b, a third backup device 300c, and a terminal 400. Hereinafter, the first backup device 300a, the second backup device 300b, and the third backup device 300c are referred to as “backup devices 300” when the devices are not particularly required to be distinguished. A system including the production storage system 200, the first backup device 300a, the second backup device 300b, and the third backup device 300c may be called a backup system.

The host 100 and the production storage system 200 are communicably connected through a network NW1. The network NW1 is a storage area network (SAN), for example.

The production storage system 200 and the first backup device 300a are communicably connected to each other through a network (not illustrated). The production storage system 200 and the second backup device 300b are communicably connected to each other through the network (not illustrated). The production storage system 200 and the third backup device 300c are communicably connected to each other through the network (not illustrated). The first backup device 300a and the terminal 400 are communicably connected to each other through the network (not illustrated). The second backup device 300b and the terminal 400 are communicably connected to each other through the network (not illustrated). The third backup device 300c and the terminal 400 are communicably connected to each other through the network (not illustrated).

The host 100 is a computer (server device) that issues an IO request. The host 100 may be a physical computer or a virtual computer. The host 100 is connected to the production storage system 200 through the network NW1. The production storage system 200 includes a volume to be provided to the host 100. The host 100 recognizes the volume when the volume is mounted on the host 100. The volume stores production data on a backup target.

The production storage system 200 includes a split processor 210, an encryption processor 220, and a storage processor 230. The split processor 210 divides backup data on the production data and creates a parity of the divided backup data (it may be referred to as “divided data”). The encryption processor 220 encrypts the divided data and the parity by using a public key corresponding to a secret key held by the backup device 300 at a storage location. The storage processor 230 stores the encrypted divided data and the encrypted parity in the first backup device 300a, the second backup device 300b, and the third backup device 300c in a distributed manner. The storage processor 230 also stores information in management information 270, the information indicating locations of the stored encrypted divided data and encrypted parity.

When updating the management information 270, the storage processor 230 transmits update contents of the management information 270 to the first backup device 300a, the second backup device 300b, and the third backup device 300c, and updates first management information 303a held by the first backup device 300a, second management information 303b held by the second backup device 300b, and third management information 303c held by the third backup device 300c according to the update contents.

Consequently, the first backup device 300a holds the first management information 303a identical in content to the management information 270 of the production storage system 200. The second backup device 300b holds the second management information 303b identical in content to the management information 270 of the production storage system 200. The third backup device 300c holds the third management information 303c identical in content to the management information 270 of the production storage system 200.

The production storage system 200 includes backup target file information 240, backup device information 250, key management information 260, and the management information 270.

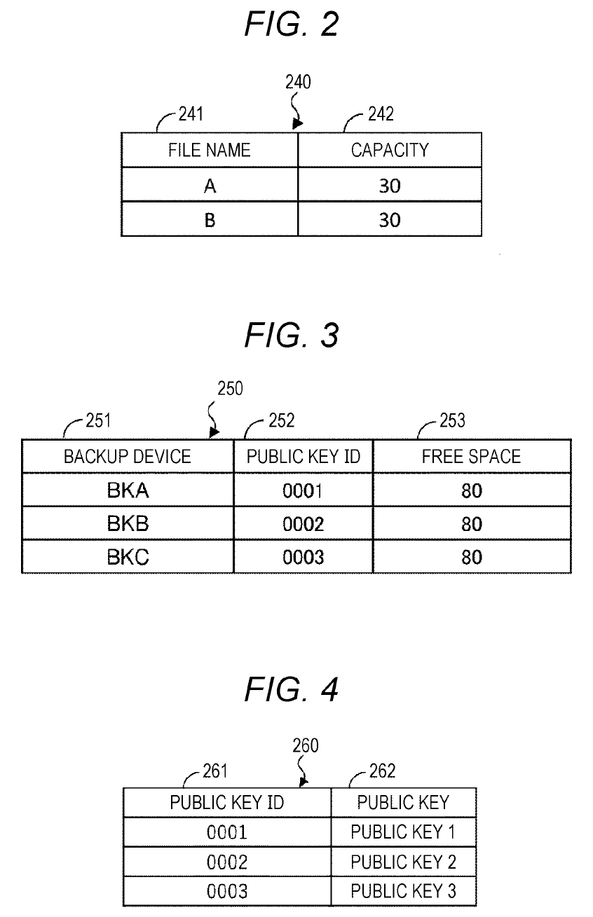

FIG. 2 is a diagram for illustrating the backup target file information 240. As illustrated in FIG. 2, the backup target file information 240 includes a file name 241 and a capacity 242 as columns in which information (values) is stored. The backup target file information 240 stores information corresponding to each column regarding a file (production data) of the backup target and being associated with each other, the information serving as information (record) in units of rows. Specifically, the file name 241 stores a name of the file of the backup target, and the capacity 242 stores data capacity of the file of the backup target.

FIG. 3 is a diagram for illustrating the backup device information 250. As illustrated in FIG. 3, the backup device information 250 includes a backup device 251, a public key ID 252, and a free space 253 as columns in which information (values) is stored.

The backup device information 250 stores information corresponding to each of columns regarding the first backup device 300a to the third backup device 300c and being associated with each other, the information serving as information (record) in units of rows. Specifically, the backup device 251 stores identification information on the backup device 300. The public key ID 252 stores an ID that is identification information on a public key corresponding to a secret key held by the corresponding backup device 300. The free space 253 stores free space of each backup device 300.

FIG. 4 is a diagram for illustrating the key management information 260. As illustrated in FIG. 4, the key management information 260 includes a public key ID 261 and a public key 262 as columns in which information (values) is stored.

The key management information 260 stores information corresponding to each column for managing the public key and being associated with each other, the information serving as information (record) in units of rows. Specifically, the public key ID 261 stores an ID of the public key. The public key 262 stores the public key used to encrypt data.

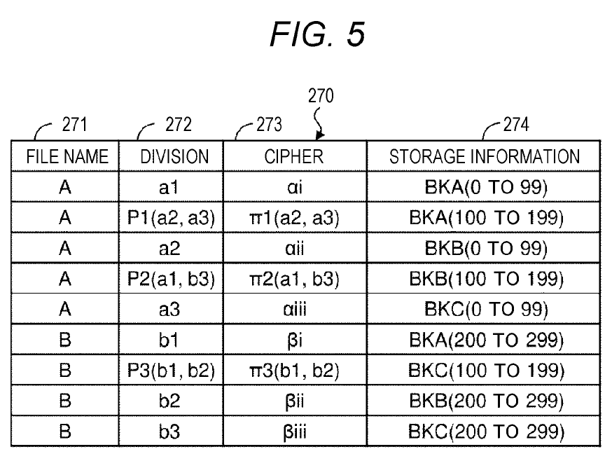

FIG. 5 is a diagram for illustrating the management information 270. As illustrated in FIG. 5, the management information 270 includes a file name 271, a division 272, a cipher 273, and storage information 274 as columns in which information (values) is stored.

The management information 270 stores information corresponding to each of columns regarding the encrypted divided data and the encrypted parity and being associated with each other, the information serving as information (record) in units of rows.

Specifically, the file name 271 stores a name of a file (backup data) of a backup target. The division 272 stores identification information indicating divided data generated by split processing. The cipher 273 stores identification information on the encrypted divided data and the encrypted parity that are generated by encryption processing. The storage information 274 stores a storage place of the corresponding encrypted divided data or encrypted parity. This example stores identification information on the backup device 300 at a storage location of data and information indicating a place (block) where the data is stored.

Referring again to FIG. 1, the first backup device 300a includes a first authentication processor 301a, a first decryption processor 302a, first management information 303a, and a first secret key 304a. The first authentication processor 301a authenticates a user of the terminal 400, the user having restore authority in the first backup device 300a. The first decryption processor 302a decrypts the divided data and the parity from the encrypted divided data and the encrypted parity, which are stored in the first backup device 300a, using the first secret key 304a. The first management information 303a is identical to the management information 270. The first secret key 304a is used to decrypt the encrypted divided data and the encrypted parity. The first secret key 304a is capable of decrypting data encrypted with a public key 1 provided in the production storage system 200.

The second backup device 300b includes a second authentication processor 301b, a second decryption processor 302b, second management information 303b, and a second secret key 304b. The second authentication processor 301b authenticates a user of the terminal 400, the user having restore authority in the second backup device 300b. The second decryption processor 302b decrypts the divided data and the parity from the encrypted divided data and the encrypted parity, which are stored in the second backup device 300b, using the second secret key 304b. The second management information 303b is identical to the management information 270. The second secret key 304b is used to decrypt the encrypted divided data and the encrypted parity. The second secret key 304b is capable of decrypting data encrypted with a public key 2 provided in the production storage system 200.

The third backup device 300c includes a third authentication processor 301c, a third decryption processor 302c, third management information 303c, and a third secret key 304c. The third authentication processor 301c authenticates a user of the terminal 400, the user having restore authority in the third backup device 300c. The third decryption processor 302c decrypts the divided data and parity data from the encrypted divided data and the encrypted parity, which are stored in the third backup device 300c, using the third secret key 304c. The third management information 303c is identical to the management information 270. The third secret key 304c is used to decrypt the encrypted divided data and the encrypted parity. The third secret key 304c is capable of decrypting data encrypted with a public key 3 provided in the production storage system 200.

The first authentication processor 301a to the third authentication processor 301c may be referred to as “authentication processor 301” when the processors are not particularly required to be distinguished. The first management information 303a to the third management information 303c may be referred to as “management information 303” when the sets of the information are not particularly required to be distinguished.

The first backup device 300a, the second backup device 300b, and the third backup device 300c preferably have backup device configurations different from each other from the viewpoint of further improving data destruction resistance. Here, the difference in a backup device configuration means that at least any one of elements is different, the elements including an operating system (OS) applied to the backup device 300, an environment (cloud environment, on-premise environment) in which the backup device 300 is constructed, and a backup technique applied to the backup device 300. Examples of the backup technique include physical write once read many (WORM), logical WORM, air gap (communication direction control), air gap (time control), logical WORM & air gap, and tape backup.

The physical WORM is performed to write and store backup data in physical WORM media. The logical WORM is performed to write and store backup data in a logical WORM (a storage device that can be written again when a period expires). The air gap (communication direction control) is performed to restrict communication between the production storage system 200 and the backup device 300 (establish unidirectional communication). The air gap (time control) is performed to restrict communication between the production storage system 200 and the backup device 300 (permit communication only in a backup time zone, for example). The logical WORM & air gap is a combination of the logical WORM and the air gap. The tape backup is performed to store data on magnetic tape.

Examples of the backup device configurations different from each other among the first backup device 300a, the second backup device 300b, and the third backup device 300c include a configuration in which the first backup device 300a is constructed in an on-premises environment, and the logical WORM & air gap is applied to the first backup device 300a. Then, the second backup device 300b is constructed in an on-premises environment and the tape backup is applied. The third backup device 300c is constructed in a cloud environment, and the logical WORM & air gap is applied to the third backup device 300c. Additionally, the first backup device 300a, the second backup device 300b, and the third backup device 300c use respective OSs different from each other.

For example, when the first backup device 300a, the second backup device 300b, and the third backup device 300c use the respective OSs different from each other, and the OSs include an OS with vulnerability, the backup device 300 using an OS other than the OS with the vulnerability has a low vulnerability caused by the OS. Even when data in the backup device 300 using the OS with the vulnerability is destroyed, backup target data can be restored using data in the backup device 300 having the low vulnerability, and thus destruction resistance of the backup system can be improved.

The terminal 400 includes a composition processor 410. The composition processor 410 requests the first backup device 300a, the second backup device 300b, and the third backup device 300c to decrypt the encrypted divided data and the encrypted parity corresponding to the file (production data) to be decrypted. The terminal 400 restores the production data by acquiring the management information 303 to acquire the decrypted divided data and parity data, and performing synthesis processing (merging) on the acquired data based on the management information 303.

### Hardware configuration

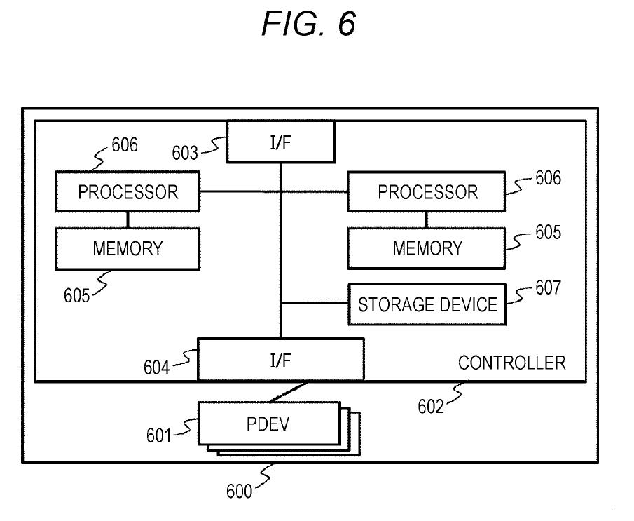

FIG. 6 is a block diagram illustrating an example of a hardware block configuration of a storage system 600 applied to the production storage system 200.

The storage system 600 includes a PDEV 601 that is a plurality of (or one) physical storage devices, and a storage controller 602 connected to the PDEV 601.

The storage controller 602 includes an I/F 603, an I/F 604, two memories 605, two processors 606 connected thereto, and a storage device 607.

The I/F 603 is a communication interface device that mediates exchange of data between an external device (e.g., the host 100) and the storage controller 602. The I/F 603 is connected to the host 100 through the network NW1.

The host 100 transmits an I/O request (a write request or a read request) designating an I/O destination (e.g., a logical volume number such as a logical unit number (LUN) or a logical address such as a logical block address (LBA)) to the storage controller 602.

The I/F 604 is a communication interface device that mediates exchange of data between a plurality of PDEVs 601 and the storage controller 602. The I/F 604 is connected to the plurality of PDEVs 601.

The memory 605 stores a program executed by the processors 606 and data used by the processors 606. Each processor 606 executes the program stored in the memory 605. This example includes a duplexed pair of the memory 605 and the processor 606.

The storage device 607 is a non-volatile storage device capable of reading and writing data. The storage device 607 stores a program to be executed and loaded into the memory 605 by the processor 606 and various types of information. The split processor 210, the encryption processor 220, and the storage processor 230 are each formed by a program. The processor 606 implements functions of each of the split processor 210, the encryption processor 220, and the storage processor 230 by executing the program. The processor 606 may also be referred to as a “processing device”. The storage device 607 stores the backup target file information 240, the backup device information 250, the key management information 260, and the management information 270, described above.

The storage system 600 illustrated in FIG. 6 may be applied to the first backup device 300a. The first backup device 300a includes the first authentication processor 301a and the first decryption processor 302a that are each formed by a program stored in the storage device 607. The first backup device 300a has the first management information 303a and the first secret key 304a that are stored in the storage device 607. The first backup device 300a may include a management server and the storage system 600. In this configuration, the management server may include the first authentication processor 301a, the first decryption processor 302a, and the first management information 303a. The first backup device 300a may be composed of a cloud storage constructed in a cloud environment. The first backup device 300a may be constructed in an on-premises environment.

The storage system 600 illustrated in FIG. 6 may be applied to the second backup device 300b. The second backup device 300b includes the second authentication processor 301b and the second decryption processor 302b that are each formed by a program stored in the storage device 607. The second backup device 300b has the second management information 303b and the second secret key 304b that are stored in the storage device 607.

The second backup device 300b may include a management server and the storage system 600. In this configuration, the management server may include the second authentication processor 301b, the second decryption processor 302b, and the second management information 303b. The second backup device 300b may be composed of a cloud storage constructed in a cloud environment. The second backup device 300b may be constructed in an on-premises environment.

The storage system 600 illustrated in FIG. 6 may be applied to the third backup device 300c. The third backup device 300c includes the third authentication processor 301c and the third decryption processor 302c that are each formed by a program stored in the storage device 607. The third backup device 300c has the third management information 303c and the third secret key 304c that are stored in the storage device 607.

The third backup device 300c may include a management server and the storage system 600. In this configuration, the management server may include the third authentication processor 301c, the third decryption processor 302c, and the third management information 303c. The third backup device 300c may be composed of a cloud storage constructed in a cloud environment. The third backup device 300c may be constructed in an on-premises environment.

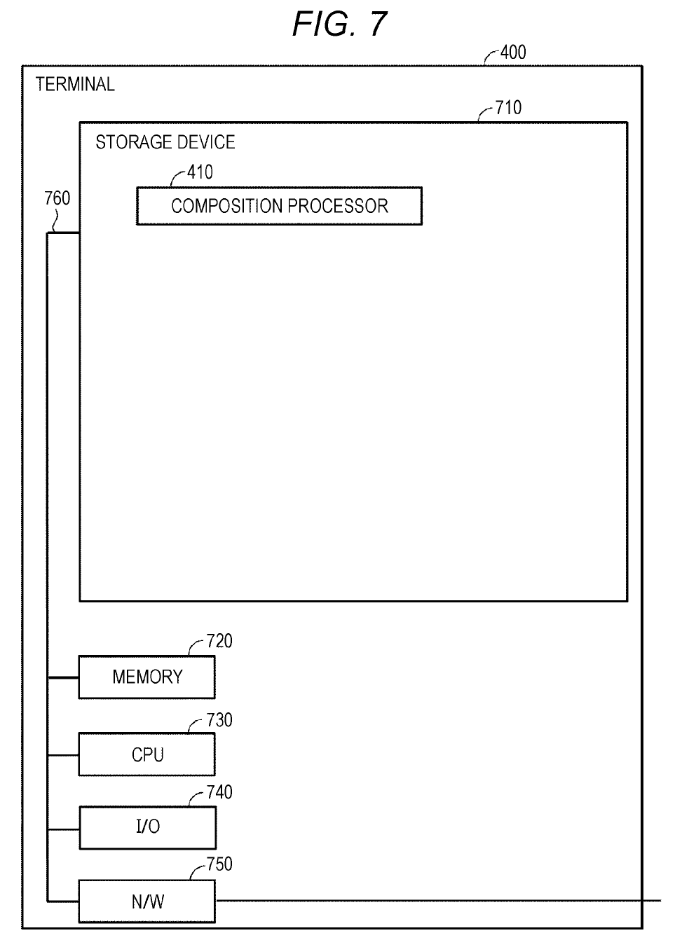

FIG. 7 is a schematic configuration diagram illustrating a hardware configuration example of the terminal 400. As illustrated in FIG. 7, the terminal 400 includes a nonvolatile storage device 710 capable of reading and writing data, a memory 720 (e.g., RAM), a CPU 730, an input/output interface 740, and a network interface 750. A device including the CPU 730, the storage device 710, the memory 720, the input/output interface 740, the network interface 750, and a bus 760 is also referred to as an “information processing device” for convenience. The information processing device may be a plurality of information processing devices or a virtual information processing device constructed on a cloud.

The storage device 710 includes the composition processor 410 as a program.

The CPU 730 loads the program stored in the storage device 710 into the memory 720. The CPU 730 is an arithmetic device that implements various functions of the terminal 400 by executing the program loaded in the memory 720.

The program executed by the CPU 730 is loaded into the memory 720 as described above, and the memory 720 temporarily stores data to be used when the CPU 730 executes the program.

The input/output interface 740 is configured to connect operation devices such as a keyboard and a mouse, a display, and the like. The network interface 750 is configured to connect the terminal 400 to a network.

At least a part of processing performed by the CPU 730 executing the program may be performed by another arithmetic device (e.g., hardware such as ASIC or FPGA).

### Overview

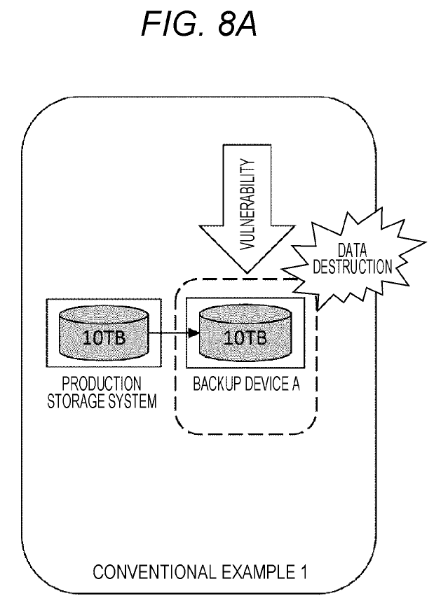

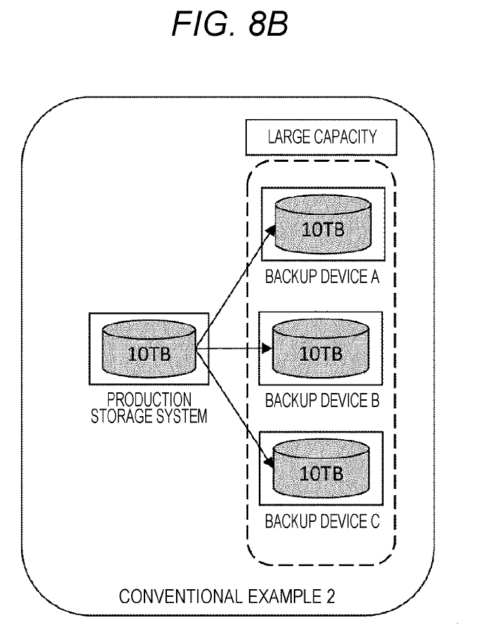

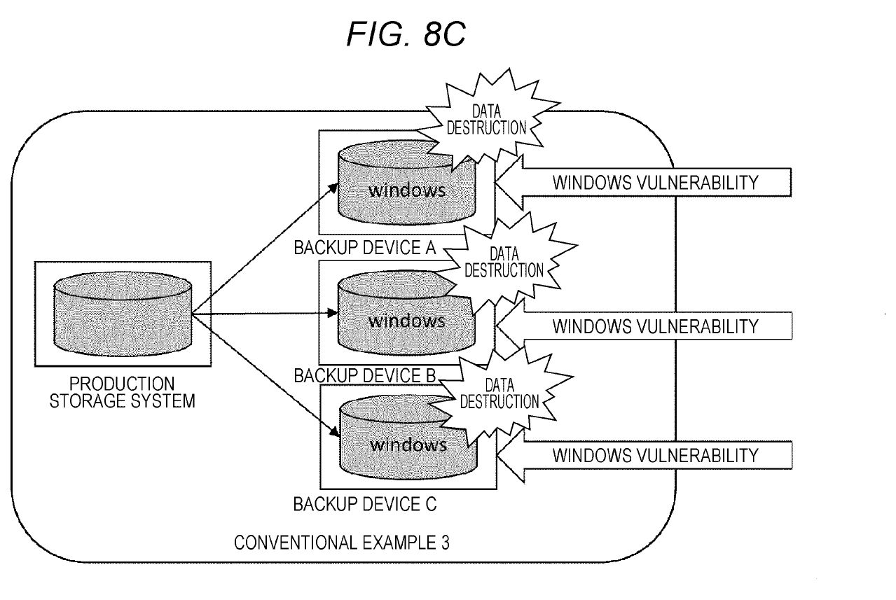

An overview of the backup system of the present disclosure will be described. FIG. 8A is a diagram for illustrating an overview of a conventional backup system. FIG. 8A illustrates the conventional backup system (conventional example 1) in which data in a production storage system is copied, and the copied data is stored in a backup device A. The conventional example 1 enables performing backup of production data at a low cost only by requiring one time capacity of the production data. However, when the backup device A is subjected to a cyberattack caused by vulnerability of the backup device A, all the backup data may be destroyed. Thus, the conventional example 1 has low data destruction resistance.

FIG. 8B is a diagram for illustrating an overview of a conventional backup system. FIG. 8B illustrates the conventional backup system (conventional example 2) in which data in a production storage system is copied, and three copies of the same backup data are stored in a backup device A, a backup device B, and a backup device C one by one. The conventional example 2 requires capacity of the backup data as large as three times capacity of data in a production storage system of a backup target. For example, when the data in the production storage system of the backup target has a capacity of 10 TB, the backup data requires a capacity of 30 TB that is three times 10 TB. Thus, although the conventional example 2 is improved in data destruction resistance as compared with the conventional example 1 by storing the same backup data in the three backup devices, the capacity three times that of the production data is required.

FIG. 8C is a diagram for illustrating an overview of a conventional backup system. FIG. 8C illustrates the conventional backup system (conventional example 3) in which backup data on data in a production storage system is dispersedly stored in a backup device A, a backup device B, and a backup device C. The backup device A, the backup device B, and the backup device C are each equipped with the same OS for operating the backup system.

When a cyberattack caused by vulnerability of the OS is performed in the conventional example 3, all the backup data is destroyed because the backup device A, the backup device B, and the backup device C have vulnerability in common. Thus, the conventional example 3 has low data destruction resistance.

As described in “SUMMARY OF THE INVENTION” and although not illustrated, the air gap backup (the air gap (communication direction control) and the air gap (time control)) restricts only a communication direction and a communicable time between the production storage system 200 and the backup system, so that both the production data and the backup data may be destroyed once or information leakage may occur when access rights for the production storage system and the backup system are illegally acquired by malware or when the production storage system and the backup system are intruded by some method. For this reason, low data destruction resistance and low leakage resistance are caused.

Although the backup technique (3-2-1 rule) arranges a plurality of copies of backup target data as backup data while not illustrated, only arranging the plurality of copies of backup data does not resolve risk of information leakage. For example, risk of data leakage due to a partial attack against the backup data is sufficiently considered. For this reason, low data leakage resistance is caused.

As described above, the backup system is required to have destruction resistance that prevents both the production data and the backup data from being destroyed at once, and leakage resistance that prevents the backup data from being stolen or prevents information leakage of even the backup data stolen. From the viewpoint of cost or the like, reduction in capacity necessary for storing the backup data is required.

In contrast, the backup system of the present disclosure uses a RAID 5 to divide the backup data on the production data while giving parity to the divided data, and arranges the divided and encrypted data in the first backup device 300a to the third backup device 300c in a distributed manner. The RAID 5 is a method for storing data in a plurality of the first backup device 300a to the third backup device 300c in a distributed manner to enable data to be restored using parity (error correction information) even when one backup device 300 fails. Specifically, the backup system of the present disclosure performs as follows: creates parities based on a plurality of pieces of divided data; determines the backup device 300 at a storage location to sequentially arrange the divided data in the plurality of backup devices 300; and determines a storage location of the parities in the backup device 300 in which corresponding divided data that can be restored by the parities is not arranged. Then, after encrypting the divided data and the parities, the backup system of the present disclosure stores the encrypted divided data and the encrypted parities in the backup device 300 at the determined storage location. The RAID 5 has a feature that does not require duplicating all the data (copy of the backup data) as many as the number of the backup devices 300 at storage locations.

As described above, the backup system of the present disclosure can restore production data using data and a parity of another backup device 300 even when data in one backup device 300 is destroyed. Thus, the backup system of the present disclosure has data destruction resistance against data destruction in one backup device 300.

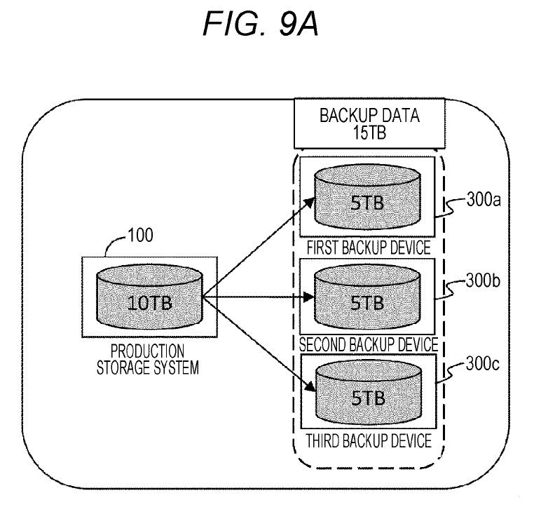

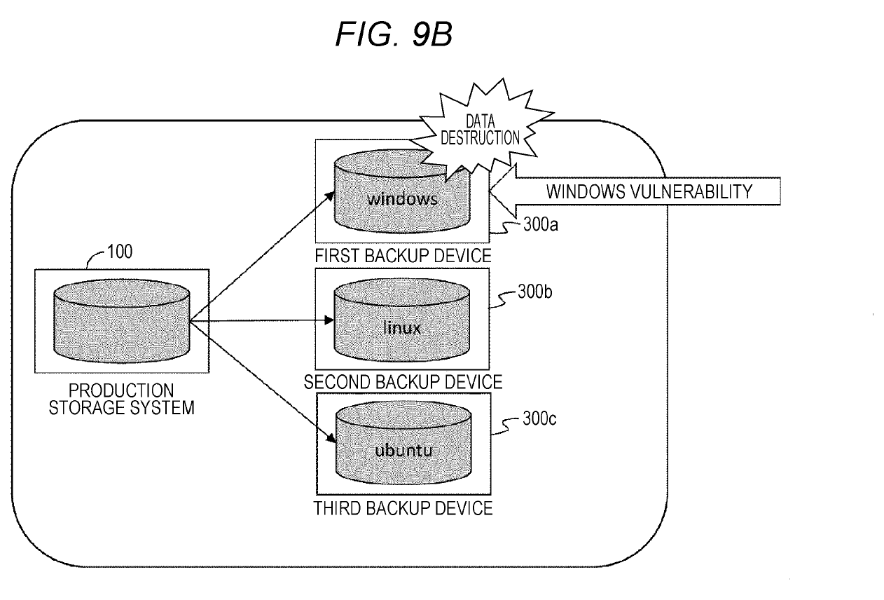

The backup system of the present disclosure further can reduce capacity required to store backup data. That is, the backup system of the present disclosure can reduce the capacity required to store the backup data as compared with the conventional example 2 of FIG. 8B as can be seen from comparison between FIGS. 8B and 9A.

The backup system of the present disclosure preferably arranges the encrypted divided data and the encrypted parity in the backup devices 300 in a distributed manner (e.g., backup devices 300 different in an OS as illustrated in FIG. 9B), the backup devices 300 being different in a backup device configuration. As illustrated in FIG. 9B, this configuration enables reduction in risk of destruction of all backup data due to vulnerability (e.g., vulnerability caused by a certain OS) caused by components of one specific backup device 300.

The backup system of the present disclosure causes each backup device 300 also to hold first management information 303a to third management information 303c for restoring backup data. Consequently, the backup system of the present disclosure can restore the backup data using the management information 303 held by the backup device 300 even when the management information 270 held by the production storage system 200 is lost due to destruction of the production storage system 200.

The backup system of the present disclosure causes the encrypted divided data and the encrypted parity to be arranged in the first backup device 300a, the second backup device 300b, and the third backup device 300c in a distributed manner. Consequently, the backup system of the present disclosure prevents the backup data from being restored even when authority of one backup device 300 is completely deprived to cause data leakage. Thus, the backup system of the present disclosure can improve leakage resistance.

The backup system of the present disclosure requires authentication for each of the backup devices 300 to read backup data from the corresponding one of the backup devices 300, so that leakage resistance can be improved because leakage does not occur only by stealing authority at one place.

### Specific operation

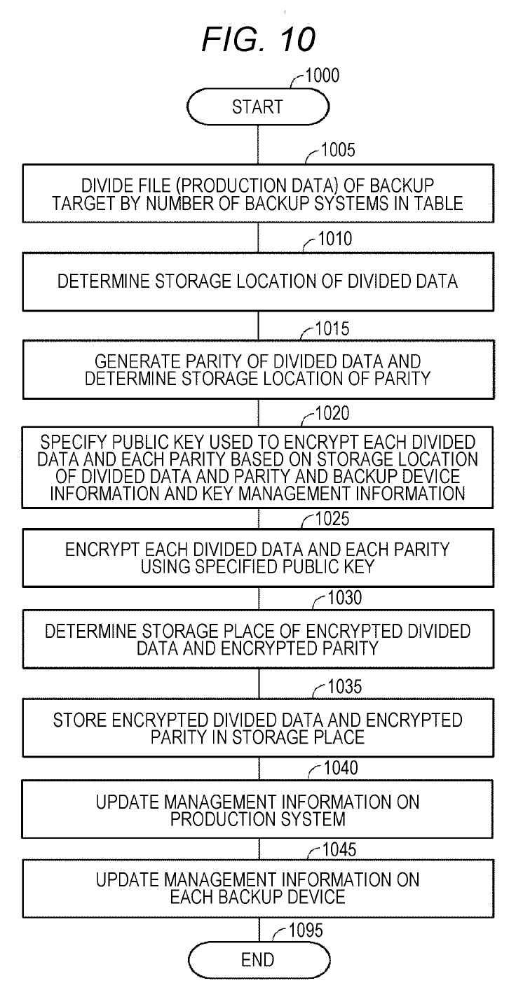

Specific operation of the backup system of the present disclosure will be described. FIG. 10 is a flowchart for illustrating backup processing performed by the production storage system 200. The production storage system 200 starts the processing from step 1000 to sequentially perform the processing in steps 1005 to 1045 described below using the split processor 210, the encryption processor 220, and the storage processor 230, and then the processing proceeds to step 1095 to temporarily end a flow of the present processing.

Step 1005 is performed as follows: The split processor 210 divides (evenly divides) a file of a backup target (production data) by the number of backup devices in the backup device information 250 to dispersedly store backup data in the file of the backup target in the first backup device 300a to the third backup device 300c using the RAID 5. For example, when the file (production data) of the backup target includes a file A and a file B, the file A is divided by the number of backup devices (three in this example) into divided data a1, divided data a2, and divided data a3, and the file B is divided by the number of backup devices (three in this example) into divided data b1, divided data b2, and divided data b3.

Step 1010 is performed as follows: The split processor 210 determines a storage location of the divided data. For example, the storage location of the divided data a1 and the divided data b1 is determined as the first backup device 300a, the storage location of the divided data a2 and the divided data b2 is determined as the second backup device 300b, and the storage location of the divided data a3 and the divided data b3 is determined as the third backup device 300c.

Step 1015 is performed as follows: The split processor 210 generates a parity of the divided data and determines a storage location of the parity. For example, a parity P1 (a2, a3) is generated based on the divided data a2 and the divided data a3, a parity P2 (a1, b3) is generated based on the divided data a1 and the divided data b3, and a parity P3 (b1, b2) is generated based on the divided data b1 and the divided data b2. The storage location of the parity P1 (a2,a3) is determined as the first backup device 300a, the storage location of the parity P2 (a1, b3) is determined as the second backup device 300b, and the storage location of the parity P3 (b1, b2) is determined as the third backup device 300c.

Steps 1010 and 1015 are performed by using the RAID 5 to determine a storage location to enable backup target data to be restored using data and a parity of another backup device 300 even when data destruction occurs in one backup device 300 of the first backup device 300a to the third backup device 300c. That is, the storage location of a plurality of parities is determined as the backup device 300 in which corresponding divided data that can be restored by the parities is not arranged.

Step 1020 is performed as follows: The encryption processor 220 specifies a public key used to encrypt each divided data and each parity based on the storage location of the divided data and the parities and the backup device information 250 and the key management information 260.

For example, when the storage location of the divided data (or parities) is the first backup device 300a, a public key ID “0001” used for encryption is specified based on the backup device information 250, and the public key 1 corresponding to the public key ID “0001” is specified as the public key used for encryption based on the key management information 260. When the storage location of the divided data (or parities) is the second backup device 300b, a public key ID “0002” used for encryption is specified based on the backup device information 250, and the public key 2 corresponding to the public key ID “0002” is specified as the public key used for encryption based on the key management information 260. For example, when the storage location of the divided data (or parities) is the third backup device 300c, a public key ID “0003” used for encryption is specified based on the backup device information 250, and the public key 3 corresponding to the public key ID “0003” is specified as the public key used for encryption based on the key management information 260.

Step 1025 is performed as follows: The encryption processor 220 encrypts each divided data and each parity using the specified public key. For example, the divided data a1 is encrypted into encrypted divided data αi using the public key 1. The divided data a2 is encrypted into encrypted divided data αii using the public key 2. The divided data a3 is encrypted into encrypted divided data αiii using the public key 3. The divided data b1 is encrypted into encrypted divided data βi using the public key 1. The divided data b2 is encrypted into encrypted divided data βii using the public key 2. The divided data b3 is encrypted into encrypted divided data βiii using the public key 3.

The parity P1 (a2, a3) is encrypted into an encrypted parity π1 (a2, a3) using the public key 1. The parity P2 (a1, b3) is encrypted into an encrypted parity π2 (a1, b3) using the public key 2. The parity P3 (b1, b2) is encrypted into an encrypted parity π3 (b1, b2) using the public key 3.

Step 1030 is performed as follows: The storage processor 230 determines storage places of each encrypted divided data and each encrypted parity (a data storage place in the backup device 300 at each storage location). For example, the storage place of the encrypted divided data αi is determined as a BKA (0 to 99) (i.e., blocks 0 to 99 of the first backup device 300a). The storage place of the encrypted parity π1 (a2, a3) is determined as a BKA (100 to 199) (i.e., blocks 100 to 199 of the first backup device 300a).

For example, the storage place of the encrypted divided data αii is determined as a BKB (0 to 99) (i.e., blocks 0 to 99 of the second backup device 300b). The storage place of the encrypted parity π2 (a1, b3) is determined as a BKA (100 to 199) (i.e., blocks 100 to 199 of the second backup device 300b).

For example, the storage place of the encrypted divided data αiii is determined as a BKC (0 to 99) (i.e., blocks 0 to 99 of the third backup device 300c). For example, the storage place of the encrypted divided data βi is determined as a BKA (200 to 299) (i.e., blocks 200 to 299 of the third backup device 300c). For example, the storage place of the encrypted parity π3 (b1, b2) is determined as a BKC (100 to 199) (i.e., blocks 100 to 199 of the third backup device 300c). For example, the storage place of the encrypted divided data βii is determined as a BKB (200 to 299) (i.e., blocks 200 to 299 of the second backup device 300b). For example, the storage place of the encrypted divided data βiii is determined as a BKC (200 to 299) (i.e., blocks 200 to 299 of the third backup device 300c).

Step 1035 is performed as follows: The storage processor 230 stores each encrypted divided data and each encrypted parity in the storage places determined in step 1030.

Step 1040 is performed as follows: The storage processor 230 updates the management information 270 on the production storage system 200 in accordance with a result of the backup processing.

Step 1045 is performed as follows: The storage processor 230 transmits update contents to each backup device 300 to update the first management information 303a to the third management information 303c of the first backup device 300a to the third backup device 300c.

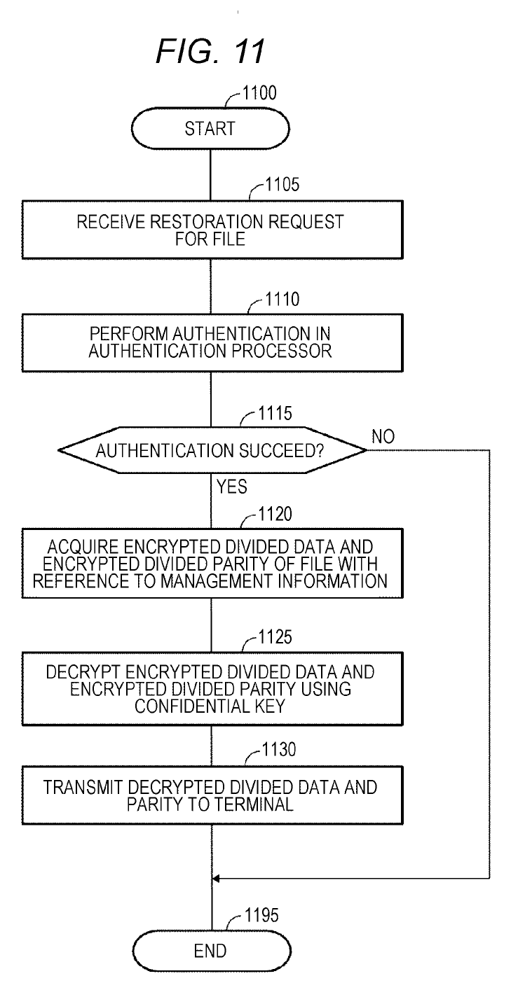

FIG. 11 is a flowchart for illustrating restoration processing performed by the first backup device 300a. The first backup device 300a starts the processing from step 1100, and the first authentication processor 301a sequentially performs the processing in step 1105 and step 1110 described below, and then the processing proceeds to step 1115.

Step 1105 is performed as follows: The first authentication processor 301a receives a restoration request for a file from the terminal 400.

Step 1110 is performed as follows: The first authentication processor 301a authenticates whether a user of the terminal 400 from which the restoration request is issued has restoration authority. Examples of an authentication method include ID password authentication using a user ID and a password.

When the processing proceeds to step 1115, the first authentication processor 301a determines whether the authentication succeeds. When the authentication fails, the first authentication processor 301a determines “NO” in step 1115 to cause the processing to proceed to step 1195, and temporarily ends a flow of the present processing.

When the authentication succeeds, the first authentication processor 301a determines “YES” in step 1115 to cause the processing to proceed to step 1120. The first decryption processor 302a sequentially performs the processing in steps 1120 to 1130 described below, and then causes the processing to proceed to step 1195 to temporarily end the flow of the present processing.

Step 1120 is performed as follows: The first decryption processor 302a refers to the first management information 303a to acquire the encrypted divided data and the encrypted divided parity data of the file.

Step 1125 is performed as follows: The first decryption processor 302a decrypts the encrypted divided data and the encrypted divided parity data using the first secret key 304a.

Step 1130 is performed as follows: The first decryption processor 302a transmits the decrypted divided data and the decrypted parity to the terminal 400.

The restoration processing performed by the second backup device 300b is similar to the restoration processing illustrated in the flowchart of FIG. 11 except that the first authentication processor 301a is replaced with the second authentication processor 301b, the first decryption processor 302a is replaced with the second decryption processor 302b, the first management information 303a is replaced with the second management information 303b, and the first secret key 304a is replaced with the second secret key 304b.

The restoration processing performed by the third backup device 300c is similar to the restoration processing illustrated in the flowchart of FIG. 11 except that the first authentication processor 301a is replaced with the third authentication processor 301c, the first decryption processor 302a is replaced with the third decryption processor 302c, the first management information 303a is replaced with the third management information 303c, and the first secret key 304a is replaced with the third secret key 304c.

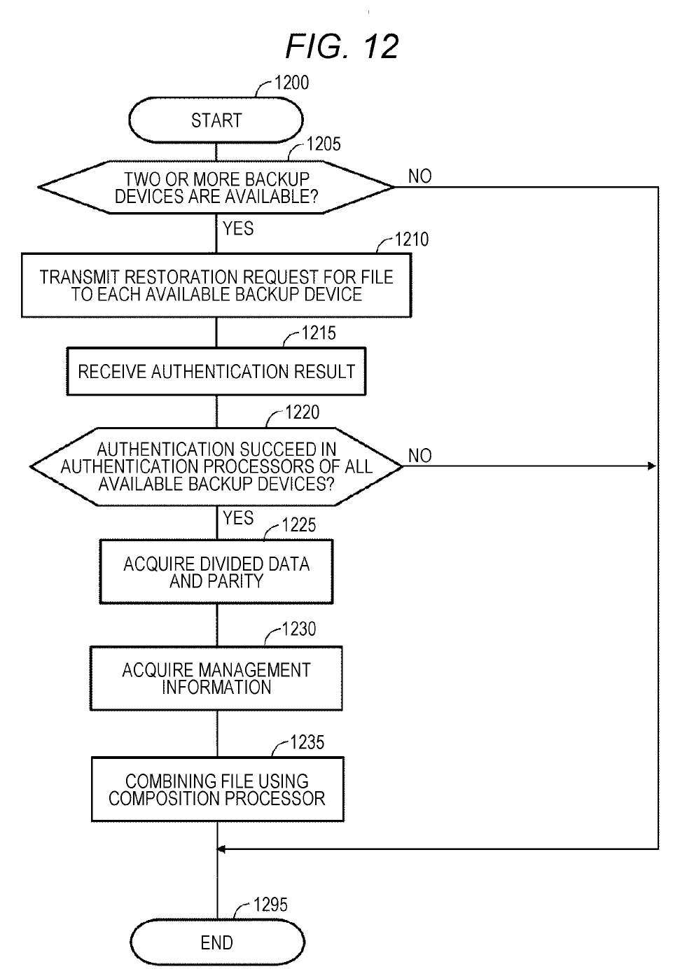

FIG. 12 is a flowchart for illustrating restoration processing performed by the terminal 400. The terminal 400 starts the processing from step 1200 to cause the processing to proceed to step 1205. In step 1205, the composition processor 410 of the terminal 400 determines whether two or more backup devices 300 among the first backup device 300a to the third backup device 300c are available. That is, it is determined whether the number of available backup devices 300 is equal to or larger than the number necessary for data restoration.

When two or more backup devices 300 among the first backup device 300a to the third backup device 300c are unavailable, the composition processor 410 determines “NO” in step 1205 to cause the processing to proceed to step 1295 to temporarily end a flow of the present processing.

When two or more backup devices 300 among the first backup device 300a to the third backup device 300c are available, the composition processor 410 determines “YES” in step 1205 to sequentially perform the processing in step 1210 and step 1215 described below, and then causes the processing to proceed to step 1220.

Step 1210 is performed as follows: The composition processor 410 transmits a restoration request for a file to each available backup device 300.

Step 1215 is performed as follows: The composition processor 410 receives an authentication result from each backup device 300.

When the processing proceeds to step 1220, the composition processor 410 determines whether the authentication has succeeded in the authentication processors 301 of all the available backup devices 300.

When the authentication has not succeeded in the authentication processors 301 of all the available backup devices 300, the composition processor 410 determines “NO” in step 1220 to cause the processing to proceed to step 1295 to temporarily end the flow of the present processing.

When the authentication has succeeded in the authentication processors 301 of all the backup devices 300, the composition processor 410 determines “YES” in step 1220 to cause the processing to proceed to step 1225 to acquire divided data and parity data from each available backup device 300. For example, when three backup devices 300 are available and the restoration target is the file A, the first backup device 300a decrypts the divided data a1 from the encrypted divided data αi and the parity P1 (a2, a3) from the encrypted parity π1 (a2, a3) using the first secret key 304a, and the divided data a1 and the parity P1 are acquired from the first backup device 300a. The second backup device 300b decrypts the divided data a2 from the encrypted divided data αii and the parity P2 (a1, b3) from the encrypted parity π2 (a1, b3) using the second secret key 304b, and the divided data a2 and the parity P1 are acquired from the second backup device 300b. The third backup device 300c decrypts the divided data a3 from the encrypted divided data αiii using the third secret key 304c, and the divided data a3 is acquired from the third backup device 300c.

After that, the composition processor 410 causes the processing to proceed to step 1230 to acquire the management information 303 from the backup device 300.

Then, the composition processor 410 causes the processing to proceed to step 1235 to specify data necessary for the file of the restoration target based on the divided data and the parity acquired in step 1225 and the management information acquired in step 1230 to combine the divided data (restore insufficient divided data from the parity and the divided data as necessary), thereby combining the file of the restoration target.

For example, when the restoration target is the file A and the three backup devices 300 are available, step 1225 is performed in which the divided data a1 and the parity P1 are acquired from the first backup device 300a, the divided data a2 and the parity P1 are acquired from the second backup device 300b, and the divided data a3 is acquired from the third backup device 300c. The composition processor 410 specifies the divided data a1, the divided data a2, and the divided data a3 necessary for the file of the restoration target based on the management information 303 (restores the insufficient divided data from the parity and the divided data as necessary), and combines the divided data a1, the divided data a2, and the divided data a3 to restore the file A.

### Effects

As described above, the backup system according to the embodiments of the present disclosure enables improvement in data destruction resistance and leakage resistance.

### Modifications

The present disclosure is not limited to the above embodiments, and various modifications can be used within the scope of the present disclosure. The above embodiments further can be combined with each other without departing from the scope of the present disclosure.

In the above embodiments, the authentication processors 301 of respective backup devices 300 may use authentication methods different from each other. The authentication methods include an example in which the first backup device 300a uses ID password authentication, the second backup device 300b uses biometric authentication (fingerprint authentication), and the third backup device 300c uses biometric authentication (face authentication). When authentication methods different from each other are used and even when data in the backup device 300 leaks due to vulnerability of one authentication method, the authentication processor 301 of each backup device 300 can prevent leakage of data for another backup device 300. That is, possibility that data is leaked due to vulnerability of only one type of authentication can be reduced. Thus, this modification enables further improvement in leakage resistance.

Although the backup system includes three backup devices 300 in the above embodiments, the backup system may include four or more backup devices 300.

The backup system may use the RAID 6 instead of the RAID 5 in the above embodiments to perform tasks of: dividing backup data; generating a parity; encrypting the backup data and the parity; and arranging the encrypted divided data and the encrypted parity in a plurality of backup devices 300 in a distributed manner. This configuration requires four or more backup devices 300.

What is claimed is:

1. A backup system comprising:
a storage system including a processing device; and
a plurality of backup devices,
the processing device being configured to perform tasks of:
creating a plurality of pieces of divided data by dividing backup target data of the storage system;
creating a plurality of parities of the plurality of pieces of divided data;
creating a plurality of pieces of encrypted divided data and a plurality of encrypted parities by encrypting the plurality of pieces of divided data and the plurality of parities; and
storing the plurality of pieces of encrypted divided data and the plurality of encrypted parities in the plurality of backup devices in a distributed manner.

2. The backup system according to claim 1, wherein
the processing device stores the plurality of pieces of encrypted divided data and the plurality of encrypted parities in each of the plurality of backup devices together with management information on storage places of the encrypted divided data and the encrypted parities necessary for restoring backup data on the backup target data.

3. The backup system according to claim 2, wherein
the plurality of backup devices includes respective authentication processors that perform authentication independently of each other.

4. The backup system according to claim 3, wherein
the authentication processors provided in the respective backup devices perform authentication using authentication methods different from each other.

5. The backup system according to claim 3, wherein
the backup devices include respective decryption processors that decrypt the encrypted divided data and the encrypted parities independently of each other.

6. The backup system according to claim 5, wherein
the storage system includes a storage unit that stores a public key,
each of the backup devices holds a secret key, and
the processing device determines the backup device at a storage location of the divided data and the parities, and generates the encrypted divided data and the encrypted parities by encrypting the divided data and the parities using the public key corresponding to the secret key held by the backup device at the storage location determined.

7. The backup system according to claim 6, wherein
the processing device performs tasks of:
creating the divided data by dividing the backup target data by a number of the backup devices;
creating a plurality of the parities based on a plurality of the divided data;
determining the backup device at a storage location to sequentially arrange the divided data in the plurality of backup devices; and
determining a storage location of the plurality of parities as the backup device in which the divided data corresponding to the parities and being restorable from the parities is not arranged.

8. The backup system according to claim 1, wherein
the backup devices are different in backup device configuration from each other.

9. The backup system according to claim 6, wherein
the plurality of backup devices is communicably connected to a terminal, and
when restoration of the backup data is requested from the terminal, each of the plurality of backup devices performs tasks of:
causing the authentication processor to perform authentication;
causing the decryption processor to decrypt the divided data and the parities from the encrypted divided data and the encrypted parities corresponding to the backup data on a restoration target, and
transmitting the decrypted divided data and the parities to the terminal.

10. The backup system according to claim 9, wherein
each of the plurality of backup devices decrypts the encrypted divided data and the encrypted parities using the secret key.

11. The backup system according to claim 9, wherein
at least one of the plurality of backup devices transmits the management information to the terminal.

12. The backup system according to claim 11, wherein
the terminal restores the backup data using the encrypted divided data and the encrypted parities based on the received management information.

13. A backup method using a storage system including a processing device and a plurality of backup devices, the backup method causing the processing device to perform tasks of:
creating a plurality of pieces of divided data by dividing backup target data in the storage system;
creating a plurality of parities of the plurality of pieces of divided data;
creating a plurality of pieces of encrypted divided data and a plurality of encrypted parities by encrypting the plurality of pieces of divided data and the plurality of parities; and
storing the plurality of pieces of encrypted divided data and the plurality of encrypted parities in the plurality of backup devices in a distributed manner.
